(19) United States
(12) Patent Application Publication
(10) Pub. No.: US 2013/0072070 A1
(43) Pub. Date: Mar. 21, 2013

(54) POWER DISTRIBUTION UNIT AND POWER INPUT MODULE THEREOF

(71) Applicants: Sheng-Nan Tsai, Taoyuan Hsien (TW); Chuang-Huan Chiu, Taoyuan Hsien (TW); Tsung-Sheng Yeh, Taoyuan Hsien (TW); Jia-Li Tsai, Taoyuan Hsien (TW); Shin-Chang Wu, Taoyuan Hsien (TW)

(72) Inventors: Sheng-Nan Tsai, Taoyuan Hsien (TW); Chuang-Huan Chiu, Taoyuan Hsien (TW); Tsung-Sheng Yeh, Taoyuan Hsien (TW); Jia-Li Tsai, Taoyuan Hsien (TW); Shin-Chang Wu, Taoyuan Hsien (TW)

(73) Assignee: DELTA ELECTRONICS, INC., Taoyuan Hsien (TW)

(21) Appl. No.: 13/529,321

(22) Filed: Jun. 21, 2012

(30) Foreign Application Priority Data
Sep. 15, 2011 (TW) 100217277

(51) Int. Cl. H01R 24/00

(52) U.S. Cl. 439/660

(57) ABSTRACT

A distribution unit includes a main body, a first electric connector, and a power input module. The main body has a receiving part. The first electric connector is located at a first end of the receiving part. The power input module is swappable to be accommodated within the receiving part. Moreover, the power input module includes a second electric connector and a third electric connector. The second electric connector is located at a first end of the power input module for receiving an input power. The third electric connector is located at a second end of the power input module. When the power input module is accommodated within the receiving part, the third electric connector is connected with the first electric connector.

### FIELD OF THE INVENTION

The present invention relates to a power distribution unit, and more particularly to a power distribution unit having a power input module, which complies with various specifications and is swappable to be accommodated within the main body of the power distribution unit in a blind-mating manner. The present invention relates to a power input module of the power distribution unit.

### BACKGROUND OF THE INVENTION

With increasing development of information industries and networks, the services provided through networks are becoming more and more appealing in various applications. Recently, with development of high-tech industries, the concepts of the cloud computing technology and the cloud storage device have been emerged, and thus the data center becomes more important. A data center is a facility used to house a plurality of computers, servers or work stations. For providing intensive network applications, the numbers of computers, servers or work stations of the data center need to be increased to exchange and store data.

Generally, a power distribution unit (PDU) is used to distribute electric power among the computers, servers or work stations of the data center. For designing a power distribution unit, the kind of utility power to be provided to the power distribution unit and the location of the power distribution unit should be determined in advance. According to the kind of utility power and the location of the power distribution unit, an exclusive power distribution unit is assembled. In such way, the power distribution unit usually fails to be used in another data center with different specifications.

Due to globalization, international corporations usually build many data centers in different countries or regions in order to increase the efficiency of the data centers. In addition, the data centers have to cooperate with the localized network service providers to establish an efficient network environment. As known, the utility power specifications for different countries or regions may be distinguished. For complying with the utility power specifications, the data centers in different countries or regions have respective exclusive power distribution units. In a case that a power distribution unit has a breakdown, the maintenance worker may replace the power distribution unit with a new one that complies with the desired utility power specification. Consequently, the cost and difficulty associated with the maintenance tasks are increased. Moreover, after the maintenance tasks are completed, it is time-consuming to have the data center return to work.

For solving the above drawbacks, the manufactures usually produce many kinds of power distribution units in order to comply with different utility power specifications. Since different power distribution units have different component specifications, the complexity of assembling the power distribution unit is increased and the fabricating cost is increased.

Therefore, there is a need of providing an improved power distribution unit so as to obviate the drawbacks encountered in the prior art.

### SUMMARY OF THE INVENTION

The present invention provides a power distribution unit and a power input module thereof. According to the concepts of the present invention, even if the utility power specifications for different countries or regions are distinguished, it is not necessary to produce many kinds of power distribution units to comply with different utility power specifications. Consequently, the complexity of assembling the power distribution units and the fabricating cost are both decreased.

The present invention also provides power distribution unit and a power input module thereof. According to the utility power specifications, a suitable power input module is selected to convert a three-phase Y-configuration power, a three-phase delta-configuration power or a single-phase power into three sets of single-phase power sources. For complying with the utility power specifications, various power input modules having respective second connectors mating with the first electric connector are employed. Moreover, the size of the power input module matches the receiving part of the power distribution unit. Since the power input module is swappable to be accommodated within the main body of the power input module in a blind-mating manner, the process of installing, maintaining and fabricating the power input module is more labor-saving and more time-saving.

In accordance with an aspect of the present invention, there is provided a power distribution unit. The power distribution unit includes a main body, a first electric connector, and a power input module. The main body has a receiving part. The first electric connector is located at a first end of the receiving part. The power input module is swappable to be accommodated within the receiving part. Moreover, the power input module includes a second electric connector and a third electric connector. The second electric connector is located at a first end of the power input module for receiving an input power. The third electric connector is located at a second end of the power input module. When the power input module is accommodated within the receiving part, the third electric connector is connected with the first electric connector.

In accordance with another aspect of the present invention, there is provided a power input module for a power distribution unit. The power distribution unit includes a main body and a first electric connector. The first electric connector is located at a first end of a receiving part of the main body. The power input module is swappable to be accommodated within the receiving part. The power input module includes a second electric connector and a third electric connector. The second electric connector is located at a first end of the power input module for receiving an input power. The third electric connector is located at a second end of the power input module. When the power input module is accommodated within the receiving part, the third electric connector is connected with the first electric connector.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating the architecture of a power distribution unit according to an embodiment of the present invention;

FIG. 2 schematically illustrates a power connection mechanism of the power input module according to an embodiment of the present invention;

FIG. 3 is a schematic perspective view illustrating the combination of the power distribution unit and the power input module as shown in FIG. 1;

FIG. 4A is a schematic functional block diagram illustrating the relation between the power distribution unit and the power input module according to an embodiment of the present invention, in which the relay control pin and the ground pin are electrically disconnected from each other; and

FIG. 4B is a schematic functional block diagram illustrating the relation between the power distribution unit and the power input module according to an embodiment of the present invention, in which the relay control pin and the ground pin are electrically connected with each other.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

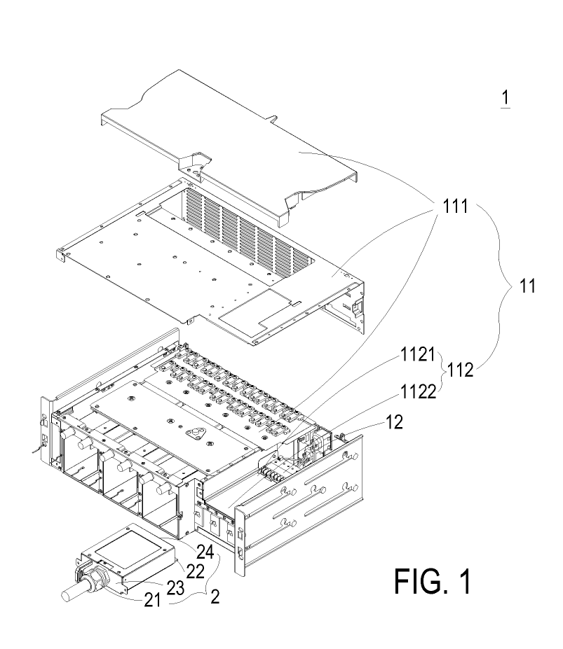

FIG. 1 is a schematic exploded view illustrating the architecture of a power distribution unit according to an embodiment of the present invention. As shown in FIG. 1, the power distribution unit (PDU) 1 comprises a main body 11, a first electric connector 12, and a power input module 2. The power distribution unit 1 is configured to distribute the input power from the utility power source to various electronic devices (e.g. computers, servers or work stations) of the data center. The main body 11 comprises a frame assembly 111 and a receiving part 112. The frame assembly 111 is used for installing a power supply apparatus or a circuit board (not shown) for converting AC-DC power or distributing or managing power output.

The receiving part 112 has a first end 1121 and a second end 1122. The first electric connector 12 is located at the first end 1121 of the receiving part 112 to be connected with the power input module 2.

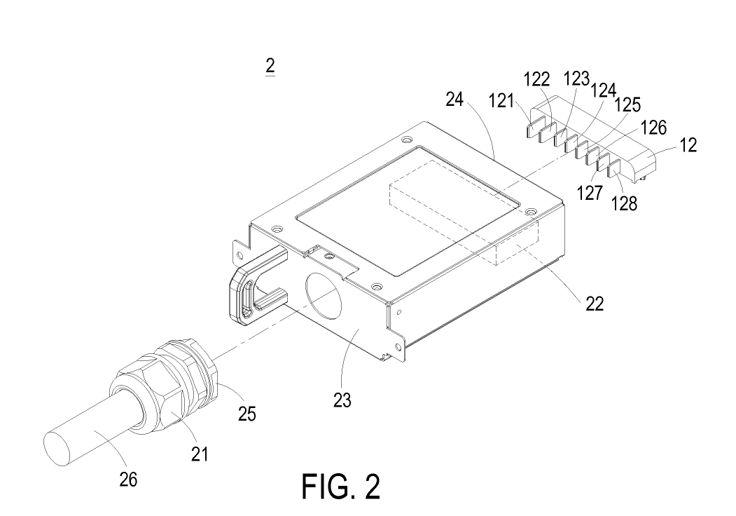

The power input module 2 is swappable to be accommodated within the receiving part 112. Moreover, the power input module 2 comprises a second electric connector 21 and a third electric connector 22. The second electric connector 21 is located at a first end 23 of the power input module 2 for receiving the input power. The third electric connector 22 is located at a second end 24 of the power input module 2. After the power input module 2 is accommodated within the receiving part 112, the third electric connector 22 is connected with the first electric connector 12. Moreover, the third electric connector 22 mates with the first electric connector 12. In some embodiments, the third electric connector 22 is located at the outer periphery of the second end 24 of the power input module 2, and may be connected with the first electric connector 12. In some embodiments, the third electric connector 22 is embedded in the inner periphery of the second end 24 of the power input module 2, and may be connected with the first electric connector 12 (see FIG. 2).

For complying with the utility power sources of different countries or regions, the second electric connector 21 of power input module 2 needs to have a specification mating with the first electric connector 12 of the power distribution unit 1. Consequently, the three-phase Y-configuration power, the three-phase delta-configuration power or the single-phase power is converted into a desired input power by the power distribution unit 1. Moreover, the size of the power input module 2 matches the receiving part 112 of the power distribution unit 1. Since the power input module 2 is swappable to be accommodated within the main body of the power input module 2 in a blind-mating manner, the process of installing, maintaining and fabricating the power input module is more labor-saving and more time-saving.

FIG. 2 schematically illustrates a power connection mechanism of the power input module according to an embodiment of the present invention. As shown in FIG. 2, the power input module 2 further comprises a fourth electric connector 25 and a power cord 26. The fourth electric connector 25 is embedded in the inner periphery of the first end 23 of the power input module 2, and may be connected with the second electric connector 21. In this embodiment, the second electric connector 21 mates with the fourth electric connector 25. Moreover, both of the second electric connector 21 and the fourth electric connector 25 comply with the IEC (International Electrotechnical Commission) specifications or the NEMA (National Electrical Manufacturers Association) specifications. Moreover, the second electric connector 21 and the fourth electric connector 25 are connected with each other in female-to-male connecting configuration or a male-to-female connecting configuration for transmitting electric power (e.g. the three-phase Y-configuration power, the three-phase delta-configuration power or the single-phase power, for example the 3-phase and 4-wire power, the 3-phase and 5-wire power or the single-phase and 2-wire power). In an embodiment, the voltage of the input power is in the range between 180 and 277 volts. Moreover, the third electric connector 22 of the power input module 2 mates with the first electric connector 12 of the power distribution unit 1. In addition, various kinds of power input modules 2 complying with different utility power specifications the third electric connector 22 should have the same third electric connectors 22. Consequently, the process of installing, maintaining and fabricating the power input module is more labor-saving and more time-saving.

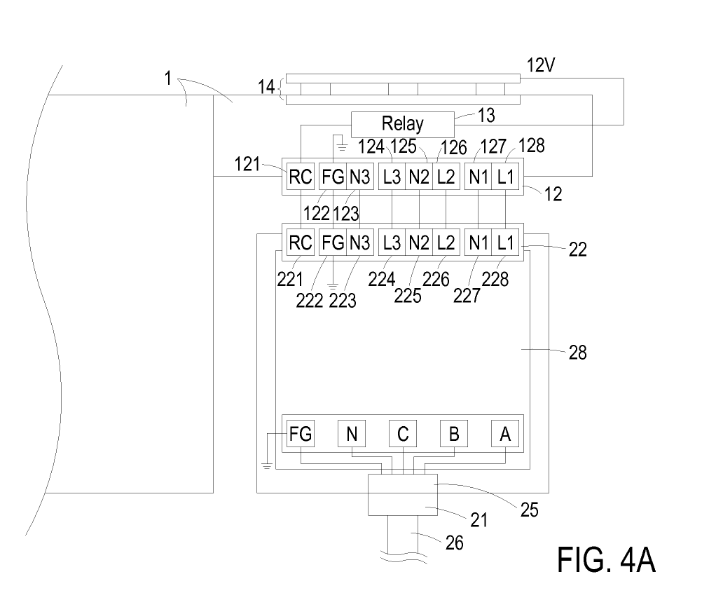

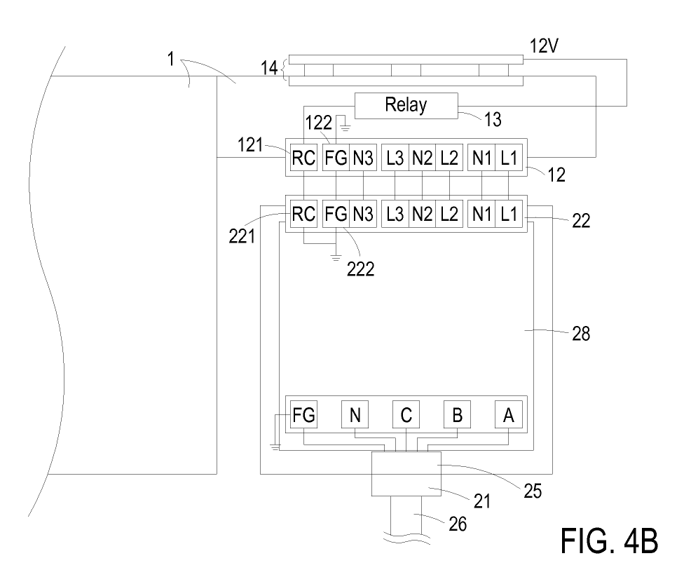

In this embodiment, the first electric connector 12 of the power distribution unit 1 comprises a first pin 121, a second pin 122, a third pin 123, a fourth pin 124, a fifth pin 125, a sixth pin 126, a seventh pin 127 and an eighth pin 128. The first pin 121 is a relay control pin (RC). The second pin 122 is a ground pin (G). The third pin 123, the fourth pin 124, the fifth pin 125, the sixth pin 126, the seventh pin 127 and the eighth pin 128 are respectively neutral pins and power pins (N3-L3, N2-L2 and N1-L1) of three sets of single-phase power sources (see FIG. 4), which are converted from a three-phase Y-configuration power, a three-phase delta-configuration power or a single-phase power. In some embodiments, the first pin 121 and the second pin 122 are longer than the third pin 123, the fourth pin 124, the fifth pin 125, the sixth pin 126, the seventh pin 127 and the eighth pin 128. In such way, during the process of installing the power input module 2, the grounding function and the relay control function are firstly enabled and thus the safety is enhanced. Moreover, during the process of installing the power input module 2, the longer first pin 121 and the longer second pin 122 can facilitate positioning the power input module 2.

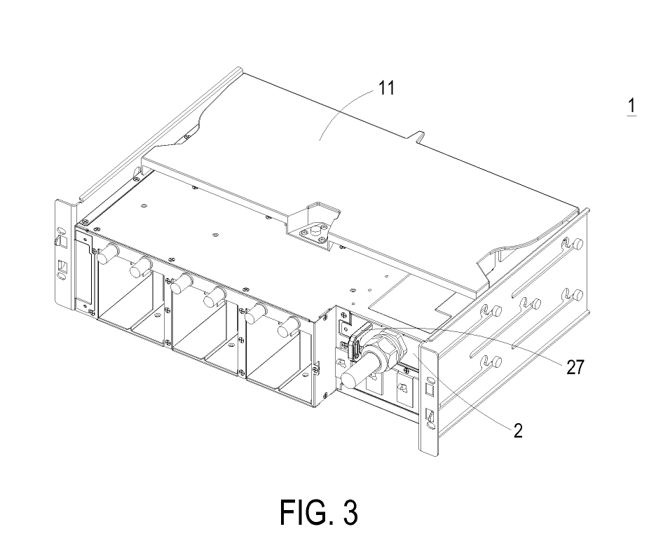

FIG. 3 is a schematic perspective view illustrating the combination of the power distribution unit and the power input module as shown in FIG. 1. As shown in FIG. 3, the power input module 2 is swappable to be accommodated within the receiving part 112 of the main body 11 of the power distribution unit 1. The power input module 2 comprises an auxiliary pulling element 27. An example of the auxiliary pulling element 27 includes but is not limited to a handle, a pull ring or a metallic hook. The auxiliary pulling element 27 is disposed on the first end 23 of the power input module 2 for facilitating removing or inserting the power input module 2.

FIG. 4A is a schematic functional block diagram illustrating the relation between the power distribution unit and the power input module according to an embodiment of the present invention, in which the relay control pin and the ground pin are electrically disconnected from each other. As shown in FIG. 4A, the circuit member 28 of the power input module 2 is connected to a first terminal A, a second terminal B, a third terminal C, a neutral terminal N and a ground terminal FG of the three-phase power wiring block through the power cord 26, the second electric connector 21 and the fourth electric connector 25. Moreover, by the circuit member 28, the electric power is distributed to a first pin 221, a second pin 222, a third pin 223, a fourth pin 224, a fifth pin 225, a sixth pin 226, a seventh pin 227 and an eighth pin 228 of the third electric connector 22. The first pin 221 is a relay control pin (RC). The second pin 222 is a ground pin (G). The third pin 223 and the fourth pin 224, the fifth pin 225 and the sixth pin 226, and the seventh pin 227 and the eighth pin 228 are neutral pins and power pins (N3-L3, N2-L2 and N1-L1) of three sets of single-phase power sources, which are converted from a three-phase Y-configuration power, a three-phase delta-configuration power or a single-phase power. The first pin 221, the second pin 222, the third pin 223, the fourth pin 224, the fifth pin 225, the sixth pin 226, the seventh pin 227 and the eighth pin 228 of the third electric connector 22 are connected with the first pin 121, the second pin 122, the third pin 123, the fourth pin 124, the fifth pin 125, the sixth pin 126, the seventh pin 127 and the eighth pin 128 of the first electric connector 12, respectively. In such way, the electric power can be transmitted to the power distribution unit 1 to be further distributed and employed by the power distribution unit 1.

FIG. 4B is a schematic functional block diagram illustrating the relation between the power distribution unit and the power input module according to an embodiment of the present invention, in which the relay control pin and the ground pin are electrically connected with each other. In some embodiments, the power distribution unit 1 further comprises a relay 13 and a DC bus 14. The relay 13 is connected with the first pin 121 of the first electric connector 12 for implementing the relay control function, thereby determining whether the current flows through the DC bus 14 or not. In a case that the first pin 221 and the second pin 222 of the power input module 2 are electrically disconnected from the relay control circuit and the ground circuit (see FIG. 4A), the relay 13 is disabled. Whereas, in a case that the first pin 221 and the second pin 222 of the power input module 2 are electrically connected with the relay control circuit and the ground circuit (see FIG. 4B). Meanwhile, since electric current is transmitted to the relay 13 through the first pin 121 of the first electric connector 12 of the power distribution unit 1, the relay 13 is enabled. Consequently, a 12V electric power is transmitted to the DC bus 14 to provide additional DC power to the computers, servers or work stations of the data center.

From the above description, the present invention provides a power distribution unit and a power input module thereof. For complying with the utility power specifications, various power input modules having respective second connectors mating with the first electric connector are employed. Moreover, the size of the power input module matches the receiving part of the power distribution unit. Since the power input module is swappable to be accommodated within the main body of the power input module in a blind-mating manner, the process of installing, maintaining and fabricating the power input module is more labor-saving and more time-saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power distribution unit, comprising:
a main body having a receiving part;
a first electric connector located at a first end of said receiving part; and
a power input module swappable to be accommodated within said receiving part, and comprising:
a second electric connector located at a first end of said power input module for receiving an input power; and
a third electric connector located at a second end of said power input module, wherein when said power input module is accommodated within said receiving part, said third electric connector is connected with said first electric connector.

2. The power distribution unit according to claim 1 wherein said first electric connector mates with said third electric connector.

3. The power distribution unit according to claim 1 wherein said third electric connector is located at an outer periphery of said second end of said power input module, or said third electric connector is embedded in an inner periphery of said second end of said power input module.

4. The power distribution unit according to claim 1 wherein said power input module further comprises a fourth electric connector and a power cord, wherein said fourth electric connector is embedded in an inner periphery of said first end of said power input module and connected with said second electric connector.

5. The power distribution unit according to claim 4 wherein said second electric connector mates with said fourth electric connector, wherein both of said second electric connector and said fourth electric connector comply with IEC (International Electrotechnical Commission) specifications or NEMA (National Electrical Manufacturers Association) specifications.

6. The power distribution unit according to claim 4 wherein said power cord is a 3-phase and 4-wire power cord, a 3-phase and 5-wire power cord or a single-phase and 2-wire power cord.

7. The power distribution unit according to claim 4 wherein said input power transmitted from said power cord has a voltage in a range between 180 and 277 volts.

8. The power distribution unit according to claim 1 wherein said first electric connector further comprises a first pin, a second pin, a third pin, a fourth pin, a fifth pin, a sixth pin, a seventh pin and an eighth pin.

9. The power distribution unit according to claim 8 wherein said first pin is a relay control pin, and said second pin is a ground pin, wherein said third pin and said fourth pin, said fifth pin and said sixth pin, and said seventh pin and said eighth pin are respective neutral pins and respective power pins of three sets of single-phase power sources.

10. The power distribution unit according to claim 9 wherein each of said first pin and said second pin is longer than said third pin, said fourth pin, said fifth pin, said sixth pin, said seventh pin and said eighth pin.

11. The power distribution unit according to claim 1 wherein said power input module further comprises an auxiliary pulling element, which is disposed on said first end of said power input module for facilitating removing said power input module from said receiving part or inserting said power input module into said receiving part.

12. The power distribution unit according to claim 1 wherein said power input module further a circuit member, which is disposed within said power input module for distributing and transmitting said input power to said third electric connector.

13. The power distribution unit according to claim 1 wherein said third electric connector further comprises a first pin, a second pin, a third pin, a fourth pin, a fifth pin, a sixth pin, a seventh pin and an eighth pin.

14. The power distribution unit according to claim 13 wherein said first pin is a relay control pin, and said second pin is a ground pin, wherein said third pin and said fourth pin, said fifth pin and said sixth pin, and said seventh pin and said eighth pin are respective neutral pins and respective power pins of three sets of single-phase power sources.

15. The power distribution unit according to claim 1 further comprising a relay and a DC bus, wherein said relay is connected with a first pin of said first electric connector for implementing a relay control function, thereby determining whether an electric current flows through said DC bus or not.

16. The power distribution unit according to claim 15 wherein when a first pin and a second pin of said third electric connector of said power input module are electrically connected with each other, an electric current is transmitted to said relay through said first pin of said first electric connector of said power distribution unit to enable said relay, so that a 12V electric power is transmitted to said DC bus.

17. A power input module for a power distribution unit, said power distribution unit comprising a main body and a first electric connector, said first electric connector being located at a first end of a receiving part of said main body, said power input module being swappable to be accommodated within said receiving part, said power input module comprising:
a second electric connector located at a first end of said power input module for receiving an input power; and
a third electric connector located at a second end of said power input module, wherein when said power input module is accommodated within said receiving part, said third electric connector is connected with said first electric connector.
